(19) United States
(12) Patent Application Publication
(10) Pub. No.: US 2016/0117969 A1
(43) Pub. Date: Apr. 28, 2016

(54) PIXEL STRUCTURE, DISPLAY PANEL AND PIXEL COMPENSATION METHOD THEREFOR

(71) Applicants: Shanghai AVIC Optoelectronics Co., Ltd., Shanghai (CN); Tianma Micro-Electronics Co., Ltd, Shenzhen (CN)

(72) Inventors: Feng QIN, Shanghai (CN); Shoufu JIAN, Shanghai (CN); Zhiqiang XIA, Shanghai (CN)

(21) Appl. No.: 14/722,095

(22) Filed: May 26, 2015

(30) Foreign Application Priority Data
Oct. 27, 2014 (CN) 201410581926.4

(51) Int. Cl. G09G 3/20

(52) U.S. Cl. CPC G09G 3/2003; G09G 3/2092; G09G 2300/0452; G09G 2300/0465; G09G 2320/0626

(57) ABSTRACT

A pixel structure including a pixel array is disclosed. The pixel array includes a plurality of pixels, each including a first sub-pixel, a second sub-pixel, and a third sub-pixel. The pixel array also includes a plurality of pixel dots, each including a plurality of sub-pixels from two adjacent rows of sub-pixels in the pixel array, wherein any two of the adjacent rows of sub-pixels in the pixel array are shared by each other. A first pixel dot includes a first sub-pixel and a plurality of surrounding sub-pixels adjacent to the first sub-pixel, wherein at least one or more of the surrounding sub-pixels and the first sub-pixel are shared by each other. In addition, the first pixel dot includes at least four sub-pixels including at least one first sub-pixel, one second sub-pixel, and one third sub-pixel.

### CROSS-REFERENCES TO RELATED APPLICATIONS

This application claims the benefit of priority to Chinese Patent Application No. 201410581926.4 filed on Oct. 27, 2014 and entitled “PIXEL STRUCTURE, DISPLAY PANEL AND PIXEL COMPENSATION METHOD THEREFOR”, the content of which is incorporated herein by reference in its entirety.

### BACKGROUND OF THE INVENTION

Display panels have been widely applied at present to a handset, a Personal Digital Assistant (PDA) and other portable electronic products, e.g., a Thin Film Transistor Liquid Crystal Display (TFT-LCD), an Organic Light Emitting Diode (OLED), a Low Temperature Poly-Silicon (LTPS) display, a Plasma Display Panel (PDP), etc. In recent years, display devices with a superior display effect and a better visual effect have become increasingly favored due to their competition for the market.

A display panel consists of a plurality of pixels, and in order to enable each single pixel to display various colors, the single pixel 101 which is a color pixel is divided into three smaller sub-pixels 102 in red, green and blue in a pixel structure as illustrated in FIG. 1. That is, the three sub-pixels are integrated together. In order to display different colors, the three sub-pixels 102 emit light respectively at different luminances and are visually mixed into a desirable color due to a very small size of the three sub-pixels 102. In the existing display panel, a pixel is equally divided into three sub-pixels, each of which is assigned with a different color, thus resulting in a color pixel.

As the display panel needs to display a picture better, the Pixel Per Inch (PPI) thereof has to be constantly improved accordingly, thus greatly lowering the transmittance of the display panel. Moreover a larger number of data lines and scanning lines required for the display panel with the high pixel per inch may come with a higher cost thereof.

### BRIEF DESCRIPTION OF THE DRAWINGS

In order to make the technical solutions according to the embodiments of the application more apparent, the drawings to which reference is made will be described briefly below in the description of the embodiments, and evidently the drawings in the following description are illustrative of only some of the embodiments of the application, and those ordinarily skilled in the art can further derive other drawings from these drawings without any inventive effort.

FIG. 1 illustrates a schematic diagram of a pixel structure in the prior art;

FIG. 2 illustrates a schematic diagram of a pixel structure according to an embodiment of the application;

FIG. 3 illustrates a schematic diagram of another pixel structure according to an embodiment of the application;

FIG. 4 illustrates a schematic diagram of a third pixel structure according to an embodiment of the application;

FIG. 5 illustrates a schematic diagram of a fourth pixel structure according to an embodiment of the application;

FIG. 6 illustrates a schematic diagram of a fifth pixel structure according to an embodiment of the application;

FIG. 7 illustrates a schematic diagram of a sixth pixel structure according to an embodiment of the application;

FIG. 8 illustrates a schematic diagram of a seventh pixel structure according to an embodiment of the application;

FIG. 9 illustrates a schematic diagram of an eighth pixel structure according to an embodiment of the application;

FIG. 10 is a structural schematic diagram of a display panel according to an embodiment of the application; and

FIG. 11 illustrates a schematic diagram of a ninth pixel structure according to an embodiment of the application.

### DETAILED DESCRIPTION OF THE PREFERRED EMBODIMENTS

The technical solutions according to the embodiments of the application will be described below clearly and fully with reference to the drawings in the embodiments of the application, and evidently the embodiments described here are only a part but not all of the embodiments of the application. All the other embodiments which can occur to those ordinarily skilled in the art based upon the embodiments here of the application without any inventive effort shall fall into the scope of the application as claimed.

An embodiment of the application provides a pixel structure including a pixel array. The pixel array includes a plurality of pixels, each of which includes a first sub-pixel, a second sub-pixel and a third sub-pixel in different colors including any permutation and combination of red, blue and green.

Any two adjacent rows of sub-pixels in the pixel array are shared by each other and constitute a plurality of pixel dots, a first pixel dot includes a first sub-pixel and several surrounding sub-pixels adjacent to the first sub-pixel, and at least one or more of the surrounding sub-pixels and the first sub-pixel are shared by each other; and the first pixel dot includes at least one first sub-pixel, second sub-pixel and third sub-pixel, and the first pixel dot includes at least four sub-pixels.

As illustrated in FIG. 2, the pixel array 201 includes a plurality of first pixel rows P1, second pixel rows P2 and third pixel rows P3, where the first pixel row P1 includes a row of the first sub-pixel SP1, the second sub-pixel SP2 and the third sub-pixel SP3 arranged in that repeated order, the second pixel row P2 includes a row of the third sub-pixel SP3, the first sub-pixel SP1 and the second sub-pixel SP2 arranged in that repeated order, and the third pixel row P3 includes a row of the second sub-pixel SP2, the third sub-pixel SP3 and the first sub-pixel SP1 arranged in that repeated order; and the plurality of sub-pixels are arranged linearly in both the row direction and the column direction.

The above-described embodiment is only one of the embodiments of the application. Alternatively, the first pixel row P1, the second pixel row P2 and the third pixel row P3 in the pixel array can be arranged in various permutations and combinations but will not be limited to the structure illustrated in FIG. 2 as long as two adjacent rows of sub-pixels are different pixel rows.

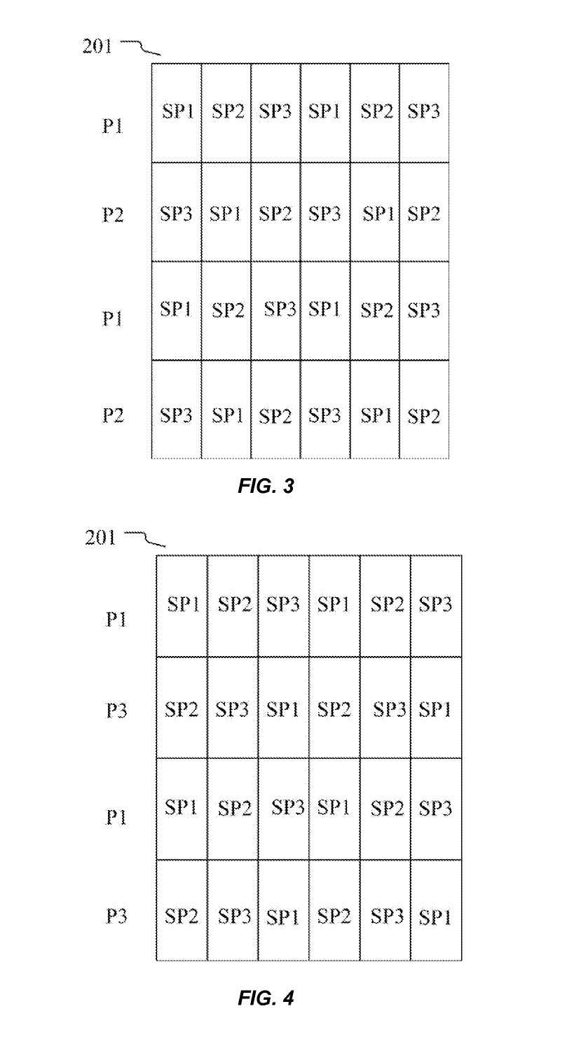

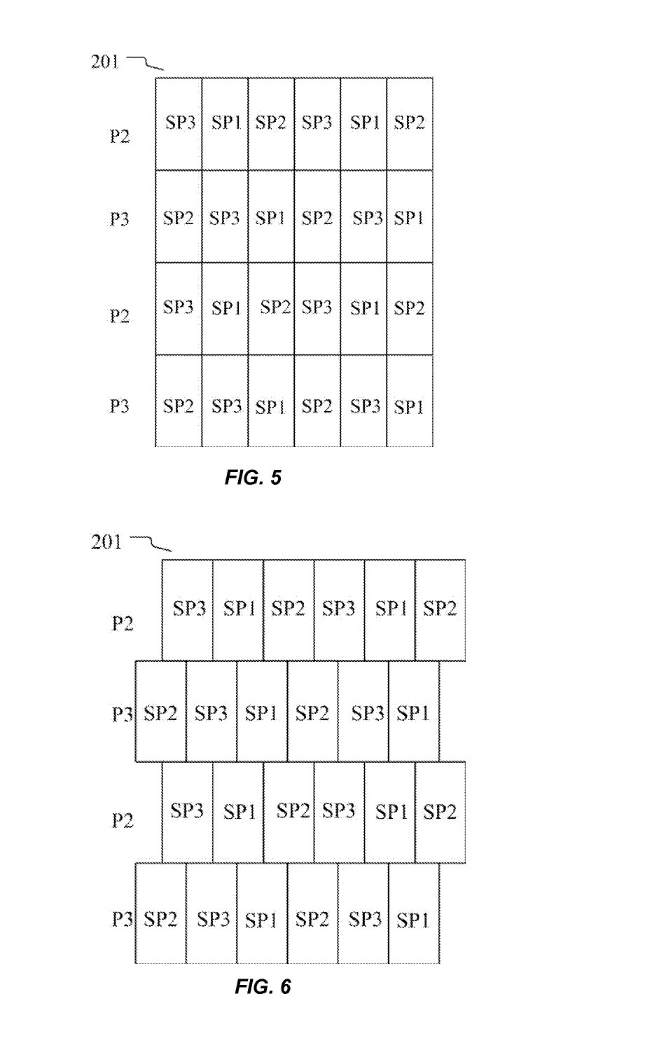

The above-described embodiment is only one of the embodiments of the application. Alternatively, an alternative structure may be possible as illustrated in FIG. 3 where the pixel array includes a plurality of first pixel rows and second pixel rows arranged alternately throughout the pixel structure; or as illustrated in FIG. 4 where the pixel array includes a plurality of first pixel rows and third pixel rows arranged alternately throughout the pixel structure; or as illustrated in FIG. 5 where the pixel array includes a plurality of second pixel rows and third pixel rows arranged alternately throughout the pixel structure; or as illustrated in FIG. 6 where the plurality of sub-pixels can alternatively be arranged zigzag in the column direction, and the horizontal offset between the adjacent rows of sub-pixels is half the length of the sub-pixels in the direction of the rows of sub-pixels.

This embodiment has been described in connection with a number of patterns in which the pixel array is arranged, and accordingly there may be more patterns in which the pixels are shared and displayed.

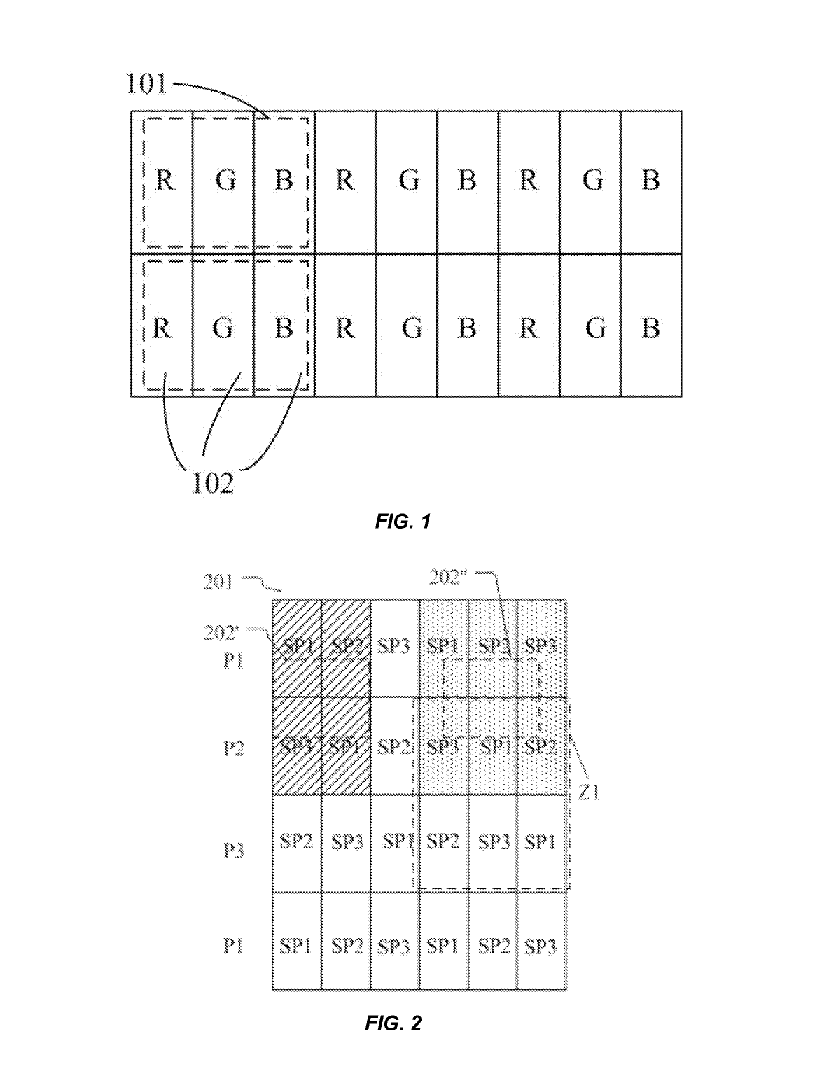

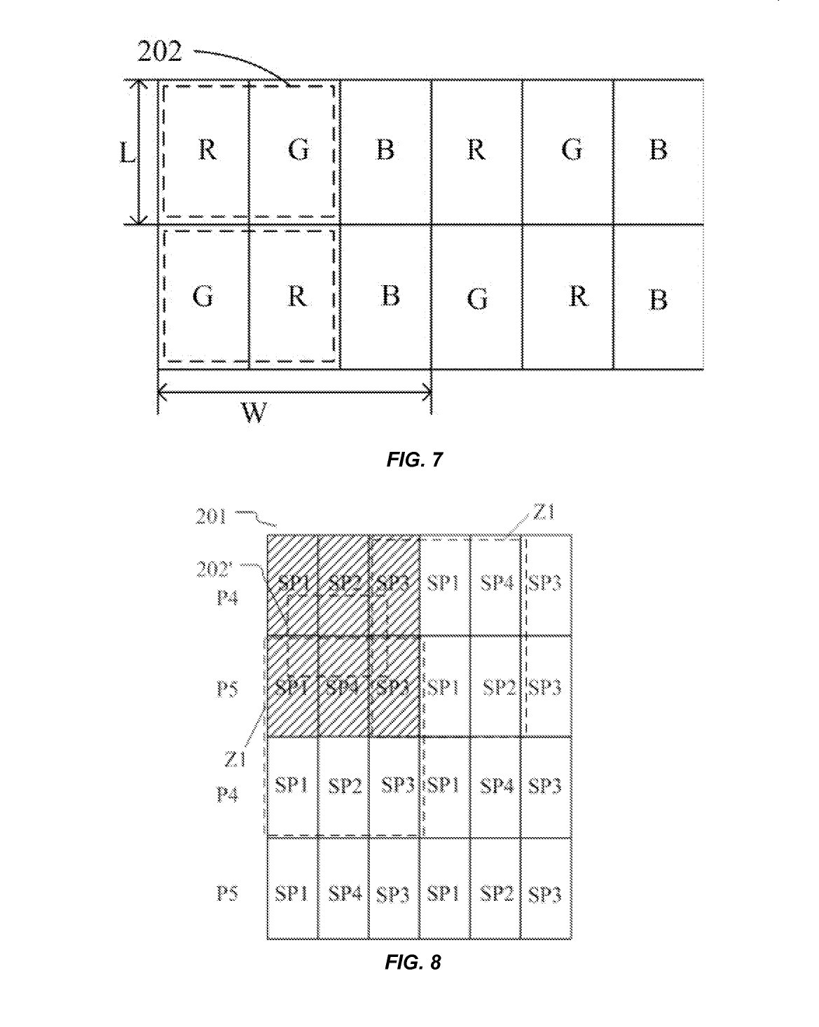

Referring to FIG. 1 and FIG. 7, in the embodiments of the application, such a virtual pixel dot solution is implemented that in the case of a lower number of physical sub-pixels on a display panel, each sub-pixel is shared by sub-pixels surrounding the sub-pixel at least once, and when each sub-pixel is shared and the number of physical sub-pixels is lowered, the length of the physical sub-pixels remains unchanged, but only the width of the sub-pixels is extended, as illustrated in FIG. 7; and in the case that the length of the sub-pixels remains unchanged, as illustrated in FIG. 1, given the pixel per inch, defined as A, in the pixel array of the display panel with the same width as in FIG. 7, no sub-pixels will be shared in a conventional process and algorithm, and the width of the desirable repeated unit including the red sub-pixel, the green sub-pixel and the blue sub-pixel at this time is defined as y, where the repeated unit is a square, and a relationship between the pixel per inch A and the width y of the repeated unit can be derived by calculating the Pixel Per Inch (PPI) as follows:

A=C/y, where C represents a constant, and C is 1 inch;

In the conventional process and algorithm, when no sub-pixels is shared, the desirable repeated unit including the red sub-pixel, the green sub-pixel and the blue sub-pixel is a virtual pixel dot as defined according to the embodiment of the application, where the width of the virtual pixel dot is y; as illustrated in FIG. 1 and FIG. 7, there is a uniform length L of a single sub-pixel, and there are different widths W of three consecutive sub-pixels in these two figures, where the width of the sub-pixels in FIG. 7 is extended; and the virtual pixel dot 202 in FIG. 7 is shaped and sized the same as the color pixel 101 in FIG. 1, and in FIG. 7, each sub-pixel is shared by each other to thereby display a virtual pixel dot as a full pixel, so that each sub-pixel can be shared by sub-pixels surrounding the sub-pixel to thereby achieve a desirable higher Pixel Per Inch (PPI) despite the lower number of physical sub-pixels in FIG. 7 than in FIG. 1.

Where the number of times that a single sub-pixel is shared is calculated according to the varying pattern in which the virtual pixel dots are arranged in the pixel array. As can be apparent from FIG. 2, two adjacent rows P1 and P2 constitute a first pixel dot, and if the first pixel dot includes the first sub-pixel SP1 and several surrounding sub-pixels adjacent to the first sub-pixel SP1, as illustrated by the biases in FIG. 2, then at least one or more of the surrounding sub-pixels and the first sub-pixel are shared by each other; the first pixel dot represented as the biases includes the first sub-pixel SP1, the second sub-pixel SP2, the first sub-pixel SP1 and the third sub-pixel SP3 arranged clockwise, and the first pixel dot is a 2×2 matrix of sub-pixels; and at this time a virtual pixel dot 202′ in the first pixel dot includes halves of the respective sub-pixels arranged clockwise, and the other halves of the respective sub-pixels are shared by another virtual pixel dot to display, and at this time each sub-pixel is shared twice. If the first pixel dot includes the first sub-pixel SP1, the second sub-pixel SP2, the third sub-pixel SP3, the second sub-pixel SP2, the first sub-pixel SP1 and the third sub-pixel SP3 arranged clockwise as illustrated by the shades in FIG. 2, and the first pixel dot is a 2×3 matrix of sub-pixels; and at this time a virtual pixel dot 202″ in the first pixel dot includes parts of the respective sub-pixels arranged clockwise, and the respective sub-pixels and sub-pixels in second pixel dot Z1 surrounding the first pixel dot are shared by each other, and at this time each sub-pixel is shared for a varying number of times, which may be 2 or 4. Actually no virtual pixel dots can be visible while a display device including the pixel structure is displaying, but the number of times that the pixels are shared needs to be calculated by determining the size of the virtual pixel dots and the pattern in which they are arranged. The number of sub-pixels of the first pixel dot and the second pixel dot can be determined and the number of times that a single sub-pixel is shared can be decided, according to the number of sub-pixels in the virtual pixel dot.

Referring to FIG. 2, in the pixel array according to the embodiment of the application, in order to achieve some requirement for Pixel Per Inch (PPI), each virtual pixel dot does not include three physical sub-pixels but includes only a part of zones of several adjacent or proximate sub-pixels, that is, each sub-pixel is divided into several zones, each of which is a virtual sub-pixel of a different pixel dot; and in the structure of the pixel array, there are a number x of virtual pixel dots in the first sub-pixel SP1, the second sub-pixel SP2 and the third sub-pixel SP3 arranged consecutively, where 1<x≦3, and given the width W of the repeated unit of the first sub-pixel SP1, the second sub-pixel SP2 and the third sub-pixel SP3, in the case that there is a uniform length of each sub-pixel, which is a unit length of 1 micrometer, if the length of a single virtual pixel dot is also a unit length of 1 micrometer, then a relationship between the width of the repeated unit of three sub-pixels and the width y of a single virtual pixel dot can be defined as follows:

W=xy,

Where y=C/A, and 1<x≦3;

In the pixel array in this case, the ratio of the length to the width of a single sub-pixel is 3: W, i.e., 3 A: Cx; and the panel including the pixel array including the shared pixels at a desirable PPI can be designed according to this ratio.

According to this embodiment of the application, it is provided the relationship between the pixel per inch and the ratio of the length to the width of a single sub-pixel, and in the design of the real panel, the pattern in which the pixels of the real panel are arranged and their sizes can be obtained simply by calculating the desirable PPI.

The above-described embodiment is only one of the embodiments of the application. Alternatively, as illustrated in FIG. 8, the pixel array includes a plurality of fourth pixel rows P4 and fifth pixel rows P5. The fourth pixel row P4 includes a row of the first sub-pixel SP1, the second sub-pixel SP2, the third sub-pixel SP3, the first sub-pixel SP1, the fourth sub-pixel SP4 and the third sub-pixel SP3 arranged in that repeated order, and the fifth pixel row P5 includes a row of the first sub-pixel SP1, the fourth sub-pixel SP4, the third sub-pixel SP3, the first sub-pixel SP1, the second sub-pixel SP2 and the third sub-pixel SP3 arranged in that repeated order, where the four sub-pixels are in different colors; and the fourth sub-pixel SP4 can be white sub-pixel or yellow sub-pixel, and the fourth pixel rows P4 and the fifth pixel rows P5 are arranged alternately in the pixel array. In the pixel array, since any two adjacent rows of sub-pixels are shared by each other, and the first pixel dot includes at least one first sub-pixel, second sub-pixel and third sub-pixel, thus the first pixel dot is a 2×3 matrix of sub-pixels, the virtual pixel dot includes parts of the respective sub-pixels in the first pixel dot, and the sub-pixels in the first pixel dot and sub-pixels in second pixel dot Z1 surrounding the first pixel dot are shared by each other. The virtual pixel dot can be arranged at different locations to thereby change the number of sub-pixels in the first pixel dot and also the number of times that the sub-pixels are shared. Moreover the plurality of sub-pixels are arranged linearly in both the row direction and the column direction.

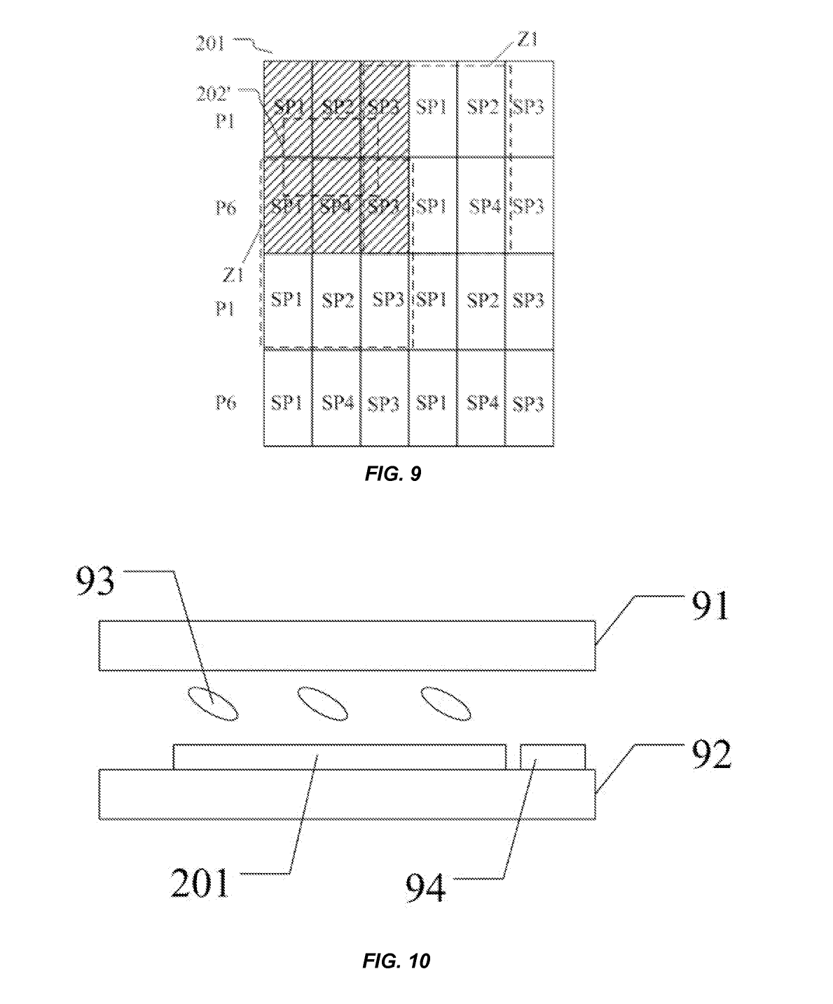

The above-described embodiment is only one of the embodiments of the application. Alternatively, as illustrated in FIG. 9, the pixel array includes a plurality of first pixel rows P1 and sixth pixel rows P6, where the first pixel row P1 includes a row of the first sub-pixel SP1, the second sub-pixel SP2 and the third sub-pixel SP3 arranged in that repeated order, and the sixth pixel row P6 includes a row of the first sub-pixel SP1, the fourth sub-pixel SP4 and the third sub-pixel SP3 arranged in that repeated order, where the four sub-pixels are in different colors; and the fourth sub-pixel SP4 can be white sub-pixel or yellow sub-pixel, and the first pixel rows P1 and the sixth pixel rows P6 are arranged alternately in the pixel array. In the pixel array, any two adjacent rows of sub-pixels are shared by each other.

The above-described embodiment is only one of the embodiments of the application. Alternatively, the plurality of sub-pixels can be arranged zigzag in the column direction, and the horizontal spacing between the adjacent rows of sub-pixels is half the length in the direction of the rows of sub-pixels.

An embodiment of the application provides a display panel including a plurality of the pixel structures described above, and a signal driver. As illustrated in FIG. 10, the display panel includes a first substrate 91, a second substrate 92, and liquid crystal molecules 83 arranged between the two substrates, there are a pixel array 201 and a signal driver 94 on the second substrate 92, and the signal driver 94 is configured to provide sub-pixels in the pixel array with a display signal while the display panel is displaying.

An embodiment of the application further provides a pixel compensation method for a display panel, applicable to the pixel structure described above, where the method includes:

Sharing at least one or more of the surrounding sub-pixels and the first sub-pixel;

Providing the first pixel dot with several sub-pixels in the same color, where the total luminance of the several sub-pixels in the same color is provided evenly by the several sub-pixels in the same color, and the total luminance of the several sub-pixels in the same color is the sum of the luminances of the several sub-pixels in the same color;

Providing sub-pixels in respective colors in the first pixel dot with the total luminance at a uniform ratio thereof to the highest luminance of each sub-pixel in the respective colors, such that for each color, the ratio of the highest luminance of the sub-pixels to the total luminance of the sub-pixels is the same as the corresponding ratio for the other colors;

Providing several further second pixel dots adjacent to the first pixel dot to surround the first pixel dot, so that the sub-pixels in the first pixel dot and sub-pixels in the second pixel dots are shared by each other; and

Inputting, by the signal driver, a signal to each sub-pixel for displaying in the displaying process of the display panel, wherein the input signal is configured to control display luminance of the sub-pixel, the display luminance of each sub-pixel is a sum of a luminance of the sub-pixel in the first pixel dot and a luminance of the sub-pixel in the second pixel dot, wherein the display luminance of each sub-pixel is the highest or maximum luminance thereof.

The display luminance of each sub-pixel is limited to the highest or maximum luminance available to each sub-pixel.

Where a single sub-pixel in the pixel structure is shared twice or four times.

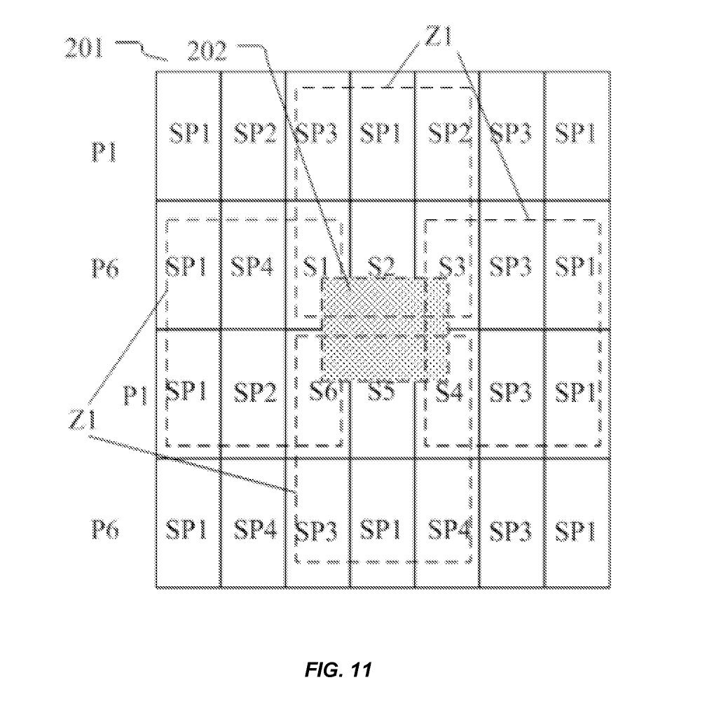

Particularly as can be apparent from FIG. 11, the first pixel dot is a 2×3 matrix of sub-pixels, there is a virtual pixel dot 202 in the first pixel dot, the first pixel dot includes the sub-pixels S1, S2, S3, S4, S5 and S6 arranged clockwise, the virtual pixel dot 202 includes parts of these six sub-pixels, and there are four second pixel dots Z1, surrounding the first pixel dot, with their sub-pixels being shared with the first pixel dot, where the sub-pixels S1, S3, S4 and S6 in the first pixel dot are shared respectively with three surrounding second pixel dots, so each of the sub-pixels S1, S3, S4 and S6 is shared for four times; and the sub-pixels S2 and S5 in the first pixel dot are shared respectively with one surrounding second pixel dot, so each of the sub-pixels S2 and S5 is shared twice.

With the pixel structure, the display panel including the pixel structure, and the pixel compensation method for the display panel according to the embodiments of the application, such a virtual pixel dot solution is implemented that each virtual pixel dot does not include three physical sub-pixels but includes only a part of zones of several adjacent or proximate sub-pixels, that is, each sub-pixel is divided into several zones, each of which is a virtual sub-pixel of a different pixel dot; and in the case of a lower number of physical sub-pixels on the display panel, each sub-pixel and surrounding the sub-pixel are shared by each other at least once, thus improving the Pixel Per Inch (PPI) and optimizing a display effect.

The pixel structure, the display panel including the pixel structure, and the pixel compensation method for the display panel according to the embodiments of the application have been described above in details, and the principle of the application and the embodiments thereof have been set forth in this context by way of several examples, but the embodiments above have been described only for the purpose of facilitating understanding of the method of the application and the core idea thereof; and moreover those ordinarily skilled in the art can modify the embodiments and application scopes of the application without departing from the spirit of the application, and in summary the disclosure of the application will not be construed as limiting the application. what is claimed is:

1. A pixel structure comprising:
a pixel array, wherein the pixel array comprises a plurality of pixels, each comprising a first sub-pixel, a second sub-pixel, and a third sub-pixel; and
a plurality of pixel dots, each comprising a plurality of sub-pixels from two adjacent rows of sub-pixels in the pixel array, wherein any two of the adjacent rows of sub-pixels in the pixel array are shared by each other, wherein a first pixel dot comprises the first sub-pixel and a plurality of surrounding sub-pixels adjacent to the first sub-pixel, wherein at least one or more of the surrounding sub-pixels and the first sub-pixel are shared by each other, and wherein the first pixel dot comprises at least four sub-pixels comprising at least one first sub-pixel, one second sub-pixel, and one third sub-pixel.

2. The pixel structure according to claim 1, wherein the first sub-pixel, the second sub-pixel, and the third sub-pixel are sub-pixels of different colors.

3. The pixel structure according to claim 1, wherein the pixel array comprises at least two of a first pixel row, a second pixel row, and a third pixel row, wherein the first pixel row comprises a row of the first sub-pixel, the second sub-pixel, and the third sub-pixel, arranged in that repeated order, the second pixel row comprises a row of the third sub-pixel, the first sub-pixel, and the second sub-pixel arranged in that repeated order, and the third pixel row comprises a row of the second sub-pixel, the third sub-pixel, and the first sub-pixel arranged in that repeated order.

4. The pixel structure according to claim 2, wherein the first pixel dot is a 2×2 matrix of sub-pixels.

5. The pixel structure according to claim 2, wherein the first pixel dot is a 2×3 matrix of sub-pixels.

6. The pixel structure according to claim 1, wherein the pixel array comprises a plurality of fourth pixel row and fifth pixel row, wherein the fourth pixel row comprises a row of the first sub-pixel, the second sub-pixel, the third sub-pixel, the first sub-pixel, fourth sub-pixel and the third sub-pixel arranged in that repeated order, and the fifth pixel row comprises a row of the first sub-pixel, the fourth sub-pixel, the third sub-pixel, the first sub-pixel, the second sub-pixel and the third sub-pixel arranged in that repeated order, and the four sub-pixels are in different colors.

7. The pixel structure according to claim 6, wherein the first pixel dot is a 2×3 matrix of sub-pixels.

8. The pixel structure according to claim 2, wherein the plurality of sub-pixels are arranged linearly in the row direction.

9. The pixel structure according to claim 8, wherein the plurality of sub-pixels are arranged linearly in the column direction.

10. The pixel structure according to claim 8, wherein the plurality of sub-pixels are arranged in a zigzag configuration in the column direction, and a horizontal offset between the adjacent rows of sub-pixels is half a length of the sub-pixels in the direction of the rows of sub-pixels.

11. The pixel structure according to claim 1, wherein the first, second, and third sub-pixels are respectively red, green, and blue sub-pixels arranged in a varying order.

12. A display panel, wherein the display panel comprises:
a plurality of pixel structures; and
a signal driver,
wherein the pixel structure comprises:
a pixel array, wherein the pixel array comprises a plurality of pixels, each comprising a first sub-pixel, a second sub-pixel, and a third sub-pixel; and
a plurality of pixel dots, each comprising a plurality of sub-pixels from two adjacent rows of sub-pixels in the pixel array, wherein any two of the adjacent rows of sub-pixels in the pixel array are shared by each other, wherein a first pixel dot comprises the first sub-pixel and a plurality of surrounding sub-pixels adjacent to the first sub-pixel, wherein at least one or more of the surrounding sub-pixels and the first sub-pixel are shared by each other, and wherein the first pixel dot comprises at least four sub-pixels comprising at least one first sub-pixel, one second sub-pixel, and one third sub-pixel.

13. A pixel compensation method for a display panel, applicable to a pixel structure comprising a pixel array, wherein the pixel array comprises:
a plurality of pixels, each comprising a first sub-pixel, a second sub-pixel, and a third sub-pixel; and
a plurality of pixel dots, each comprising a plurality of sub-pixels from two adjacent rows of sub-pixels in the pixel array, wherein any two of the adjacent rows of sub-pixels in the pixel array are shared by each other, wherein a first pixel dot comprises the first sub-pixel and a plurality of surrounding sub-pixels adjacent to the first sub-pixel, wherein at least one or more of the surrounding sub-pixels and the first sub-pixel are shared by each other, and wherein the first pixel dot comprises at least four sub-pixels comprising at least one first sub-pixel, one second sub-pixel, and one third sub-pixel,
wherein the method comprises:
sharing at least one of the surrounding sub-pixels and the first sub-pixel;
providing the first pixel dot with several sub-pixels of a same color, wherein a total luminance of the several sub-pixels of the same color is provided evenly by the several sub-pixels of the same color, and wherein the total luminance of the several sub-pixels of the same color is a sum of the luminances of the several sub-pixels of the same color;
providing sub-pixels of respective colors in the first pixel dot with the total luminance at a uniform ratio thereof to a highest luminance of each sub-pixel of the respective colors, such that for each color, the ratio of the highest luminance of the sub-pixels to the total luminance of the sub-pixels is the same as the corresponding ratio for the other colors;
providing several additional second pixel dots adjacent to the first pixel dot to surround the first pixel dot, wherein the sub-pixels in the first pixel dot and sub-pixels in the second pixel dot are shared by each other; and
inputting, by a signal driver, a signal to each sub-pixel of the display panel, wherein the input signal is configured to control display luminance of the sub-pixel, wherein the display luminance of each sub-pixel is a sum of a luminance of the sub-pixel in the first pixel dot and a luminance of the sub-pixel in the second pixel dot, and wherein the display luminance of each sub-pixel is the maximum luminance thereof.

14. The pixel compensation method for the display panel according to claim 13, wherein a single sub-pixel in the pixel structure is shared twice or four times.
